(19) United States
(12) Patent Application Publication
(10) Pub. No.: US 2013/0335419 A1
(43) Pub. Date: Dec. 19, 2013

(54) CONSUMER HISTORY GRAPHICS

(71) Applicants: Laura C. Bondesen, Charlotte, NC (US); Elizabeth S. Votaw, Potomac, MD (US)

(72) Inventors: Laura C. Bondesen, Charlotte, NC (US); Elizabeth S. Votaw, Potomac, MD (US)

(73) Assignee: Bank of America, Charlotte, NC (US)

(21) Appl. No.: 13/495,347

(22) Filed: Jun. 13, 2012

(51) Int. Cl. G06T 11/20

(52) U.S. Cl. 345/440

(57) ABSTRACT

Apparatus for calculating and displaying a banking customer's banking history is provided. The apparatus may include a receiver configured to receive a first set of data relating to a plurality of deposits and a plurality of withdrawals. Each of the plurality of deposits and each of the plurality of withdrawals may be associated with a numerical value and a calendar date. The apparatus may further include a graphical user interface. The graphical user interface may be configured to display a timeline in a first screen region. The timeline may include a plurality of demarcations, each of the demarcations being associated with a calendar date. The graphical user interface may be further configured to display in a second screen region a plurality of balloons. Each of the plurality of balloons may display one or more deposits and withdrawals included in the first set of data.

### FIELD OF TECHNOLOGY

This invention relates to a tool for use in displaying features of a customer's past, present and/or future relationship with a business.

### BACKGROUND OF THE DISCLOSURE

Many businesses desire to strengthen their customer relationships. Reminding customers of previous business interactions may assist in strengthening this relationship. For example, reminding a banking customer of his visits to a bank, usage of web banking and/or opening a new savings account may reinforce the banking customer's awareness of the centrality of the bank in his life.

It would be desirable, therefore, to provide one or more graphical interfaces that display to a customer a plurality of interaction(s) that took place between a business and the customer.

Sentimentality, personal milestones and/or memories may be attached to one or more of a customer's business interactions. It follows that enabling a customer to associate personal milestones with business interactions may be used to further reinforce the customer-business relationship.

It would, therefore, be further desirable to enable a customer to associate one or more personal milestones with interaction(s) that took place between a business and the customer.

Businesses may also strengthen customer relationships by projecting future customer benefits and/or future customer events that may occur in the event that their customers continue their relationship with the business. After projecting the future benefits, the businesses may display the projected future benefits to their customers. A customer viewing these benefits may find that her desire to maintain a long-term business relationship has been increased.

It would be further desirable, therefore, to provide one or more graphical user interfaces that display to a customer a projected future benefit that he may receive as a result of a long-term relationship with a business.

### SUMMARY OF THE DISCLOSURE

A method for calculating and displaying a banking customer's banking history is provided. The method may include using a receiver configured to receive a first set of data relating to a plurality of deposits and a plurality of withdrawals. Each of the plurality of deposits and each of the plurality of withdrawals may be associated with a numerical value and a calendar date. The method may additionally include using a processor to display on a graphical user interface a timeline included in a first screen region. The timeline may include a plurality of demarcations, each of the demarcations being associated with a calendar date. The method may further include using the processor to further display on the graphical user interface a plurality of balloons included in a second screen region. Each of the plurality of balloons may display one or more deposits and withdrawals included in the first set of data.

Each of the one or more deposits and withdrawals displayed in a balloon may be associated with the same calendar date. Additionally, a size of a two-dimensional area occupied by each of the plurality of balloons may be determined at least in part based on the sum of each of the values associated with the one or more deposits and withdrawals displayed in the balloon.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the systems and methods of the invention;

FIG. 2 shows another apparatus that may be used in accordance with the systems and methods of the invention;

FIG. 3 shows yet another apparatus that may be used in accordance with the systems and methods of the invention;

FIG. 4 shows a graphical display that may be generated and displayed in accordance with the systems and methods of the invention;

FIG. 5 shows another graphical display that may be generated and displayed in accordance with the systems and methods of the invention;

FIG. 6 shows yet another graphical display that may be generated and displayed in accordance with the systems and methods of the invention;

FIG. 7 shows yet another graphical display that may be generated and displayed in accordance with the systems and methods of the invention;

FIG. 8 shows yet another graphical display that may be generated and displayed in accordance with the systems and methods of the invention;

FIG. 9 shows yet another graphical display that may be generated and displayed in accordance with the systems and methods of the invention;

FIG. 10 shows yet another graphical display that may be generated and displayed in accordance with the systems and methods of the invention; and

FIG. 11 shows yet another graphical display that may be generated and displayed in accordance with the systems and methods of the invention.

### DETAILED DESCRIPTION OF THE DISCLOSURE

The systems and methods of the invention relate to assisting one or more businesses in strengthening their customer relationships.

The systems and methods of the invention may be used by any business that has one or more customers using products and/or services offered by the business. Such businesses may include financial institutions (banks, investment houses, etc.), shopping malls, stores, restaurants and any other suitable businesses. It should be noted that these businesses may include one or more brick and mortar locations and/or one or more websites.

For the purposes of the disclosure, an exemplary business using the systems and methods of the invention may be referred to as a financial institution or a bank. However, it should be noted that any of the businesses described above may use one or more of the systems and methods of the invention.

The systems and methods of the invention may include a consumer graphics engine. The consumer graphics engine may include a plurality of modules. Exemplary modules that may be included in the consumer graphics engine are a calendar module and/or a timeline module.

The consumer graphics engine may be implemented on any suitable electronic device. Exemplary electronic devices include a computer, personal digital assistant (“PDA”), mobile phone, smart phone and/or tablet. In some embodiments, the consumer graphics engine may be accessed by initiating an online banking session. In other embodiments, the consumer graphics engine may be accessed using an application stored on a mobile phone, smart phone and/or tablet.

The calendar module and/or the timeline module may generate one or more consumer graphics. It should be noted that the calendar module and/or the timeline module may generate consumer history graphics (referred to alternatively hereinafter as “consumer graphics”) for one or more customers. In some embodiments, each consumer graphic may include information associated with a single customer. In some embodiments, one or more consumer graphics may include information associated with two or more customers. It should additionally be noted that consumer graphics generated using a customer's information may be electronically accessed by the customer in one or more password-encoded locations, such as an online banking portal, a smartphone application and/or a tablet application.

Each of the consumer graphics may relate to at least a portion of a customer's past, present and/or future relationship with a business. The calendar module and/or the timeline module may access data relating to the customer's business relationship from one or more customer databases to create the consumer graphics.

For example, in the event that the business using the systems and methods of the invention is a bank, the data accessed may include data relating to a customer's relationship with a bank. In some embodiments, data relating to each of the customer's bank accounts may be accessed. In other embodiments, data relating to one or more of the customer's bank accounts may be accessed. In some embodiments, a customer may select which bank account(s) he desires to be included in the creation of his consumer graphics.

Data relating to some or all of the customer's interaction with the bank may also be accessed by the calendar module and/or the timeline module. At least some of this data may be associated with a date, time and/or value. Table A below includes exemplary data relating to a customer's interaction with the bank that may be accessed.

TABLE A
Customer-Bank Interaction(s)

| Venue for Customer-Bank Interaction: | Customer-Bank Interaction: |
|---|---|
| Customer Online Banking/ | deposit of cash/check |
| Mobile Phone Banking Application | withdrawal |
| | transfer |
| | redemption of reward points |
| | online bill pay |
| In-Person Banking at a Brick and Mortar | deposit of cash/check |
| Bank | withdrawal |
| | transfer |
| | redemption of reward points |
| | bill payment |
| | account opening/closure |
| | purchasing an investment |
| | selling an investment |
| Automated Teller Machine (“ATM”) | deposit of cash/check |
| | withdrawal |
| | bill payment |

Additionally, the data accessed may include any data relating to one or more customer bank accounts, such as account balances and account activity. At least some of this data may be associated with a date, time and/or value. Table B below includes exemplary customer bank account data.

TABLE B
Customer Account Data

| Customer Account | Account Activity |
|---|---|
| Checking Account | account balance |
| | direct deposit |
| | automatic bill payment |
| | electronic transfer of funds from a third party |
| | account |
| | interest payment |
| | fee charged/fee paid |
| Savings Account | account balance |
| | electronic transfer of funds from a third party |
| | account |
| | interest payment |
| | fee charged/fee paid |
| Investment Account | value of investment account |
| | dividend paid |
| | increase/decrease in investment value |
| | fee charged/fee paid |

It should be noted that the aforementioned data is exemplary only. Any data associated with a customer of a financial institution may be accessed by either the calendar module and/or the timeline module included in the systems and methods of the invention.

The calendar module and/or the timeline module may also use projected customer data to generate at least a portion of one or more consumer graphics. Data included in the projected customer data may be associated with a date, time and/or a value. In exemplary embodiments, the calendar module and/or the timeline module may receive and/or access projected customer data to generate consumer graphics that predict a customer's future history with a business. The projected customer data may be calculated by one or more processors using one or more algorithms. Data used by the processor(s) may include one or more pieces of data detailed in Tables A and B above and stored in the one or more customer databases, in addition to any other suitable data.

Projected customer data may include one or more customer events, such as a deposit, withdrawal and/or a bill payment. In the event that a customer event is determined to be a one-time occurrence, the customer event may be associated with a single calendar date. In the event that a customer event is determined to occur two or more times, the customer event may be associated with two or more calendar dates. In the event that a customer event is determined to be recurring, the customer event may be associated with one or more calendar dates or with one or more time intervals, measured from a current or past date, or any other suitable date and/or interval.

Exemplary recurring customer events include one or more recurring withdrawals that are executed by the customer using an automatic bill pay function. For example, bills that a customer is paying daily, weekly, bi-weekly or monthly using an online bill pay function may be determined to be projected account withdrawals on the daily, weekly, bi-monthly and/or monthly basis.

Additionally, any account withdrawals having similar characteristics may be determined by the customer graphics engine to be recurring account withdrawals. In some embodiments, two or more executed withdrawals that (1) are of equal value or similar value and (2) that occur on the same or similar calendar dates may be determined to be a recurring account withdrawal. In some embodiments, three or more executed withdrawals that (1) are of equal value or similar value and (2) that have equal or similar time gaps between them may be determined to be a recurring account withdrawal.

Exemplary projected recurring account deposits may include deposits currently being executed using direct deposit, in addition to monthly deposits with similar characteristics.

In the event that the calendar module and/or the timeline module use projected data in a portion of a generated graphical display, a clear indicator may be included on the consumer graphic that separates the portion of the graphical display that was calculated using past customer activity from a portion of the graphical display that was calculated using projected data.

Additionally, the calendar module and/or the timeline module may access customer data input by a customer into the consumer graphics engine. Exemplary data input by a customer into the consumer graphics engine may include any customer activity that the consumer predicts will occur in the future, such as a projected deposit of funds, bills to be paid, withdrawal of funds, loans and/or mortgages. The customer may include this information by inputting information into input fields, selecting from drop-down lists, responding to predetermined questions and/or by clicking on a future calendar date and inputting a deposit and/or withdrawal value. It should be noted that the customer may further specify if one or more customer activities are expected to recur. In these embodiments, the customer may input the parameters of the recurrence into the consumer graphics engine.

It should be noted that in the event that the calendar module and/or the timeline module generate a consumer graphic based on a first set of data, and a customer subsequently inputs a second set of data into the consumer graphics engine, the calendar module and/or the timeline module may subsequently recalculate the consumer graphic using both the first set of data and the second set of data. This may enable a customer to visualize the impact of different future decisions on his financial future. It should be noted that both the first set of data and the second set of data may include any data included in Tables A and B and/or any other data described herein.

The calendar module and/or the timeline module may include functionalities that enable a user to associate one or more milestones with a portion of a displayed consumer graphic, such as a calendar date or a point on a timeline. For example, a user may input information into the calendar module that relates to his birthday, wedding date and planned vacation. The calendar module may subsequently display the input information on the calendar dates associated with the personal milestone. It should be noted that, in some embodiments, some or all customer information input into the calendar module may be substantially immediately accessed by the timeline module and incorporated into one or more consumer graphics generated by the timeline module.

The calendar module and/or the timeline module may additionally enable a user to associate photographs, links to one or more websites and/or personal comments with to a portion of their generated consumer graphics, such as a calendar date or a point on a timeline.

In some embodiments, the consumer graphics engine may query a customer's account activity for uncharacteristic customer data. In the event that uncharacteristic data is identified, such as an unusually large deposit or withdrawal, the consumer graphics engine may suggest the customer add a milestone to one or more of their consumer graphics based on the uncharacteristic customer data.

The Calendar Module

The calendar module may generate a graphical display of a calendar day, week, month, two or more months, or year. The number of calendar day(s) displayed may be predetermined or user selected. In some embodiments a default graphical display, such as a calendar month, may be displayed and a user may subsequently select an option to view a different subset of calendar days, such as a calendar week.

The calendar module may populate the displayed calendar date(s) with customer-business interactions that took place on the displayed calendar date(s). In some embodiments, each piece of data displayed may include a time of day during which the described activity took place. In some of these embodiments, the data displayed on each calendar data may be displayed in the order in which they occurred. It should be noted that in the event that there is insufficient space on a calendar date to display all activity that took place on the calendar date, the calendar date may indicate to the user to execute a user selection of the calendar date. Selection of the calendar date may generate a display of the complete customer activity that took place on the calendar date.

In some embodiments, the calendar module may display some or all of the data included in Tables A and B, in addition to other suitable customer data. In other embodiments, data used to populate the calendar dates may be user-selected from a list of selectable options.

The calendar module may also include a bank account balance for one or more displayed calendar dates. It should be noted that in some embodiments, a bank account balance for two or more bank accounts may be displayed. A bank account balance for a calendar date prior to the current date may be the bank account balance at 11:59 pm on the calendar date, the bank account balance at 5:00 pm on the calendar date or the average bank account balance on the calendar date. A bank account balance for a current date may be updated hourly or in real-time. A bank account balance may be updated in any suitable fashion or any suitable period. A bank account balance for a future calendar date may be a projected bank account balance. It should be noted that a projected bank account balance may be calculated based at least in part on one or more pieces of data associated with the customer and stored in one or more databases.

The graphical displayed generated by the calendar module may include selectable arrows that, when selected, alter the calendar date(s) displayed. For example, in the event that a calendar week is displayed by the calendar module, a first selectable arrow may enable a user to view a calendar week that precedes the displayed calendar week. Additionally, a second selectable arrow may enable a user to view a calendar week that follows the displayed calendar week.

In the event that the graphical displayed generated by the calendar module is displayed on a device that includes touch screen functionality, finger strokes may be used to alter the calendar date(s) displayed. For example, a finger stroke from left to right may enable a user to view calendar date(s) that precede displayed calendar dates. Also, a finger stroke from right to left may enable a user to view calendar date(s) that follow the displayed calendar dates.

In some embodiments, a user may associate a personal milestone with a calendar date by clicking on the calendar date and inputting information relating to the personal milestone. In other embodiments, in the event that a user input milestone information into one or more input fields, the calendar module may subsequently populate the identified calendar date with at least some of the input information. It should be noted that any other method suitable for associating a personal milestone with a calendar date may be used by the systems and methods of the invention.

In some embodiments, the calendar module may include a connection to a native calendar stored on an electronic device that has access to the systems and methods of the invention. In these embodiments, the calendar module may display an option to import some or all of the data displayed by the calendar module into the native calendar. It should be noted that a customer may select the date(s) for which he desires data to be imported and/or the date(s) may be predefined.

The Timeline Module

The timeline module may use data from one or more customer databases to electronically generate and display one or more timelines. The data may include one or more pieces of data detailed in Tables A and B and/or other suitable data. Alternatively, the data included in the timelines may be user-selected.

A timeline generated by the timeline module may include a plurality of customer data, each piece of customer data being associated with a date, a time and/or a value. In some embodiments, customer data displayed on a timeline may be customer data associated with time span relating to a portion of a day. In some embodiments, customer data displayed on a timeline may be customer data associated with a time span relating to one or more days, weeks, months or years. The time span may be predetermined or user selected. In some embodiments a default time span, such as a calendar month, may be included on the timeline and a user may subsequently select an option to view data associated with a different time span, such as a calendar year.

The timeline may include selectable arrows that, when selected, alter a time span displayed. For example, in the event that the time span of a calendar week is represented on a timeline, a first selectable arrow may enable a user to view a time span of a calendar week that precedes the displayed time span. Additionally, a second selectable arrow may enable a user to view a time span of a calendar week that follows the displayed time span.

In the event that the timeline is displayed on a device that includes touch screen functionality, finger strokes may be used to alter a time span displayed. For example, a finger stroke from left to right may enable a user to view a time span that includes a period of time preceding the displayed time span. Also, a finger stroke from right to left may enable a user to view a period of time that follows the displayed time span.

An exemplary timeline generated by the timeline module may include a vertical line or a horizontal line. The vertical line or the horizontal line may be included in a first screen region. The line may include demarcations. Each demarcation may correspond to a calendar date.

The timeline may additionally include one or more balloons. The one or more balloons may be included in a second screen region. Each of the balloons may be associated with a demarcation. For example, a balloon may include a line that connects a balloon to a demarcation. Alternatively, a balloon may include an indicator such as an arrow that visually associates a balloon with a demarcation. It should be noted that the first screen region may be adjacent to the second screen region, surrounded by the second screen region, or included in the second screen region.

The balloons may each display one or more pieces of customer data. Exemplary customer data may include deposits, withdrawals, customer visits to a bank, ATM activity, etc. It should be noted that deposits may include any activity that increases the value of a customer bank account. It should additionally be noted that withdrawals may include any activity that decreases the value of a customer bank account, such as using a debit card, paying bills online, and cash withdrawals.

Each piece of customer data displayed may be associated with a date and/or a time. Some of the customer data displayed may also be associated with a value. It should be noted that customer data relating to deposits may be associated with a positive value and customer data relating to withdrawals may be associated with a negative value.

In some embodiments, all customer data displayed in a balloon may be associated with the same calendar date. In some embodiments, a balloon may display the calendar date associated with customer data. It should be noted that the calendar date associated with each piece of customer data may be the same calendar date associated with a demarcation associated with the balloon.

In some embodiments, the balloons may also display an account balance of one or more customer accounts. The account balance may be an account balance associated with the calendar date displayed in the balloon. An account balance for a calendar date prior to the current date may be the bank account balance at 11:59 pm on the calendar date, the bank account balance at 5:00 pm on the calendar date or the average account balance on the calendar date. A bank account balance for a current date may be updated hourly or in real-time. A bank account balance may be updated in any suitable fashion or any suitable period. A bank account balance for a future calendar date may be a projected bank account balance. It should be noted that a projected bank account balance may be calculated based at least in part on one or more pieces of data associated with the customer and stored in one or more databases.

In some embodiments, a value may be calculated for each balloon (referred to alternatively hereinafter as a ‘balloon value’). The balloon value may be calculated by summing the value(s) associated with the customer data displayed in the balloon. Alternatively, this value may be calculated by determining the absolute values of each of the values associated with the displayed customer data and subsequently summing the determined absolute values.

In some embodiments, the larger the balloon value the large the size of the balloon—i.e. the two dimensional area occupied by the balloon—and, in some embodiments, the larger the text included in the balloon. It should be noted that a minimum balloon size and a maximum balloon size may be included in the timeline module.

In other embodiments, the balloon value may be determined based at least in part on the balloon value in relation to a customer's account balance or total net worth. For example, customer A may have an account balance of $20,000. For customer A, a balloon with a balloon value of $500 may have a small size. Customer B, in contrast, may have an account balance of $1,000. For customer B, a balloon with a balloon value of $500 may have a large size.

In other embodiments, the size of a balloon may be correlated with the balloon's balloon value in relation to the balloon value of the other balloons displayed by the timeline module. Thus, in these embodiments, the balloon value with the largest value may be the largest balloon, and the balloon with the smallest value may be the smallest balloon.

Additionally, in some embodiments, the two dimensional area enclosed by one or more of the balloons may include a color. In some embodiments, a balloon that includes a value of a deposit that is either greater than a predetermined value or greater than a predetermined percentage of the account into which it is being deposited may be displayed in green. In some embodiments, a balloon that includes a value of a withdrawal that is either greater than a predetermined value or greater than a predetermined percentage of the account from which the funds are being withdrawn from may be displayed in red.

A timeline module displaying a timeline and associated balloons may receive new customer data in real-time or upon the lapse of a predetermined time period. Receipt of the new data may prompt the timeline module to display a new balloon or add data to a currently-displayed balloon. In the event that a new balloon is to be displayed, the receipt of new data may generate a repositioning command. The repositioning command may initiate the change of the spatial location of one or more of the balloons to make room for the new balloon. The repositioning command may also initiate the change of the size of one or more of the balloons. In the event that new data is to be added to a balloon, the receipt of the data may generate a repositioning command initiating the change in the size of at least one of the balloons.

In some embodiments, the timeline module may display a two-dimensional graph that plots benefits that a customer has accrued and/or will accrue by using one or more products offered by a business. The y-axis may represent the value of the benefit that the customer has accrued. The x-axis may represent calendar days, months, weeks or years. Thus, at least a plurality of (x,y) values on the graph may represent the benefit that a customer has accrued at a specified date.

In some of these embodiments, each benefit accrued from a single business product may be graphed on its own graph. In other embodiments, two or more benefits may be graphed on the same graph. In yet other embodiments, the benefits received from two or more products as a function of time may be added and displayed on the same graph. In some of these embodiments, the graph may include markings indicating which portion(s) of the total value of benefits is attributed to each of the benefits.

In the embodiments wherein the business is a financial institution, the timeline module may display the benefits that a customer has accrued and/or will accrue by using one or more products offered by the bank.

In some embodiments, the timeline module may display a two-dimensional graph that plots the net worth of a client as a function of time. In some embodiments, the net worth of the client may include the account balance of a particular customer account as a function of time.

In other embodiments, the net worth of the client may include the sum of two or more of the client's accounts, such as a client's savings and checking accounts, or each of a client's savings account, checking account and investments held at the financial institution. In some of these embodiments, the account balance of each account may be graphed as a function of time on a separate graph. In other embodiments, the timeline module may graph the account balance of each account as a function of time on the same graph. In yet other embodiments, the account balance of each of the accounts may be summed and displayed on a graph. In some of these embodiments, the graph may include markings indicating which portions of the total net worth of the client is attributable to which bank account.

It should be noted that the consumer graphics generated by the consumer graphics engine may include sharing capabilities. For example, options may be included in the consumer graphics engine to electronically transmit one or more generated consumer graphics to one or more electronic destinations. For example, the options may include e-mailing the consumer graphics and/or uploading the consumer graphics to a social networking site. These options may enable a user to select which information he desires to include in the electronic transmission and/or which information he desires to exclude from the electronic transmission. In the event that the business using the systems and methods of the invention is a bank, the electronic transmission may include a logo of the bank and/or text stating that the values included in the transmission are actual account balances of the customer.

As will be appreciated by one of skill in the art, the invention described herein may be embodied in whole or in part as a method, a data processing system, or a computer program product. Accordingly, the invention described herein may take the form of an entirely hardware embodiment, an entirely software embodiment or an embodiment combining software, hardware and any other suitable approach or apparatus.

For example, the consumer graphics engine and/or one or more of the modules included in the consumer graphics engine may be embodied in whole or in part as a method, a data processing system, or a computer program product. Accordingly, the consumer graphics engine and/or one or more of the modules included in the consumer graphics engine may take the form of an entirely hardware embodiment, an entirely software embodiment or an embodiment combining software, hardware and any other suitable approach or apparatus.

Furthermore, aspects of the invention, such as the consumer graphics engine and/or one or more of the modules included in the consumer graphics engine, may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

In an exemplary embodiment, in the event that the consumer graphics engine and/or one or more of the modules included in the consumer graphics engine is embodied at least partially in hardware, the consumer graphics engine and/or one or more of the modules included in the consumer graphics engine may include one or more databases, receivers, transmitters, processors, modules including hardware and/or any other suitable hardware. Furthermore, the operations executed by the consumer graphics engine and/or one or more of the modules included in the consumer graphics engine may be performed by the one or more databases, receivers, transmitters, processors and/or modules including hardware.

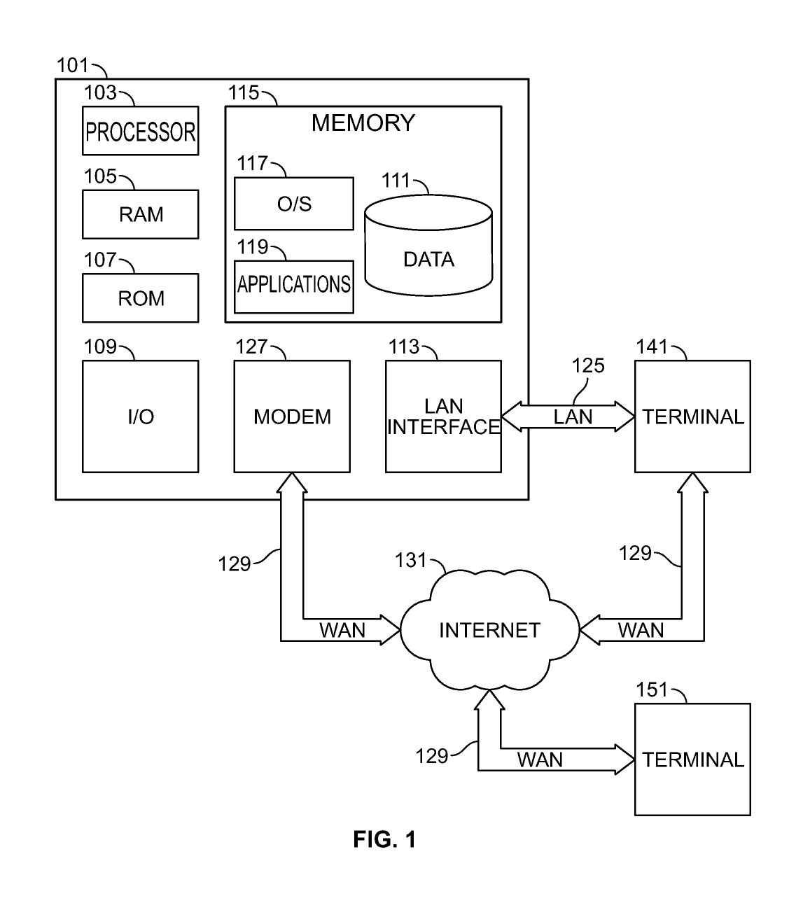

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115. It should be noted that the computer server 101 may perform one or more of the functions of the consumer graphics engine and/or the one or more modules included in the consumer graphics engine according to the systems and methods of the invention.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, smart phone, Blackberry™, tablet, or any other suitable device for storing, transmitting and/or transporting relevant information.

Any information described above in connection with database 111, and any other suitable information, may be stored in memory 115.

One or more of applications 119 may include one or more algorithms that may be used to by processor 103 to calculate and display one or more consumer graphics generated by the systems and methods of the invention.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones, smart phones, tablets and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. The program modules may include hardware and/or software, such as routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

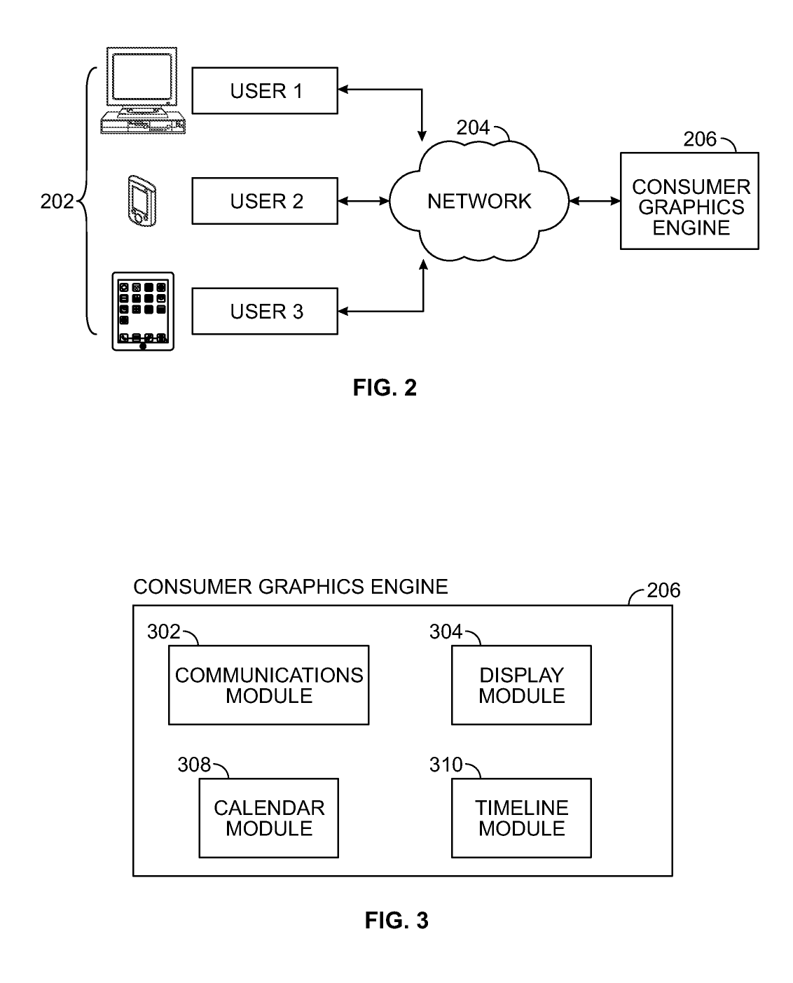

FIG. 2 shows illustrative apparatus that may be used in accordance with the systems and methods of the invention. FIG. 2 includes users 202. Users 202 may include one or more customers in electronic communication with consumer graphics engine 206. Users 202 may access consumer graphics engine 206 via network 204. Network 204 may be any suitable communications network that enables the transmission of information between two or more locations.

Users 202 may access network 204 using any device. For example, User 1 may use a computer to access network 204, user 2 may use a cellular phone to access network 204, and user 3 may use a tablet to access network 204. Each of the computer, cellular phone and tablet may be in electronic communication with network 204 via a wireless or hardware connection. It should be noted that the aforementioned devices are exemplary only. Any suitable electronic device may be used to access network 204.

FIG. 3 shows an exemplary consumer graphics engine 206 that may be used in accordance with the systems and methods of the invention. Consumer graphics engine 206 is shown to include a plurality of modules. It should be noted that the modules included in FIG. 3 are for illustrative purposes only. A consumer graphics engine according to the invention may include a subset of the displayed modules and/or additional modules not displayed in FIG. 3.

In FIG. 3, consumer graphics engine 206 includes communications module 302. Communications module 302 may be used to receive data from one or more users 202. Communications module 302 may also be used to send data to one or more users 202. Consumer graphics engine 206 may also include display module 304. Display module 304 may be configured to display to a customer one or more graphics generated by calendar module 308 and/or timeline module 310. It should be noted that in these or other embodiments, calendar module 308 and/or timeline module 301 may include display capabilities that include displaying the one or more generated graphics.

Consumer graphics engine may further include calendar module 308 and timeline module 310. Calendar module 308 and timeline module 310 may be configured to access customer data and generate one or more consumer graphics that include at least a portion of the accessed customer data. It should be noted that, in some of these embodiments, calendar module 308 and timeline module 310 may receive customer data transmitted from one or more databases.

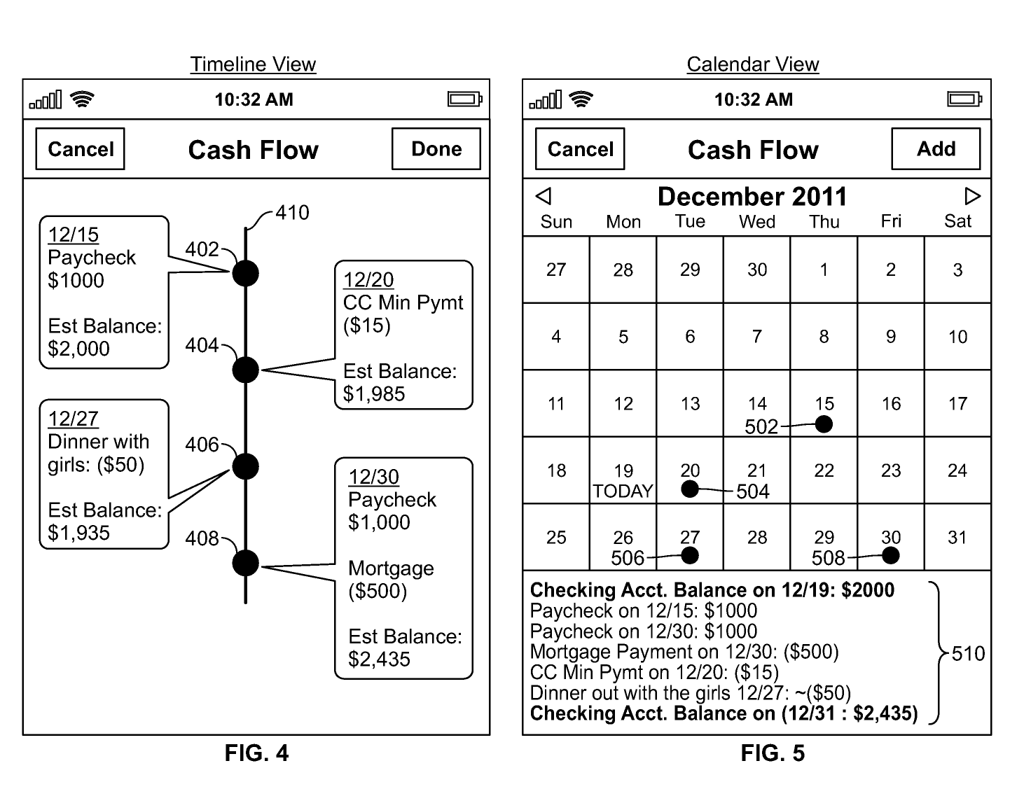

FIG. 4 shows an exemplary graphical display that may be generated and displayed by a timeline module in accordance with the systems and methods of the invention. The graphical display in FIG. 4 includes timeline 410. Timeline 410 includes demarcations 402, 404, 406 and 408. Each of demarcations 402, 404, 406 and 408 are electronically associated with the respective calendar dates December 15, December 20, December 27 and December 30.

The timeline displayed in FIG. 4 additionally includes four balloons. Each of the four balloons are associated with a calendar date. The calendar date associated with each of the balloons is displayed in the balloon. Furthermore, each of the balloons include an indicator that points towards a demarcation included on the timeline which is associated with the same calendar date displayed in the balloon. For example, demarcation 402 is associated with December 15. The balloon displaying the date “12/15” points towards demarcation 402 and displays customer activity that took place on December 15.

Each of the balloons display customer data. The customer data includes customer deposits and customer withdrawals. It should be noted that the displayed customer data may be either data that took place in the past or data that is projected to take place in the future.

FIG. 5 shows an exemplary graphical display that may be generated and displayed by a calendar module in accordance with the systems and methods of the invention. The calendar displayed in FIG. 5 includes the calendar dates of the month of December 2011. The calendar has displayed circles 502, 504, 506 and 508 on the respective calendar dates December 15, 20, 27 and 30. It should be noted that, in FIG. 5, a circle displayed on a calendar date indicates that account activity took place on the calendar date.

FIG. 5 additionally includes display field 510. Display field 510 details the account activity that took place on December 15, 20, 27 and 30. Display field 510 also displays a current account balance of $2,000 and a projected future account balance of $2,435 on December 31.

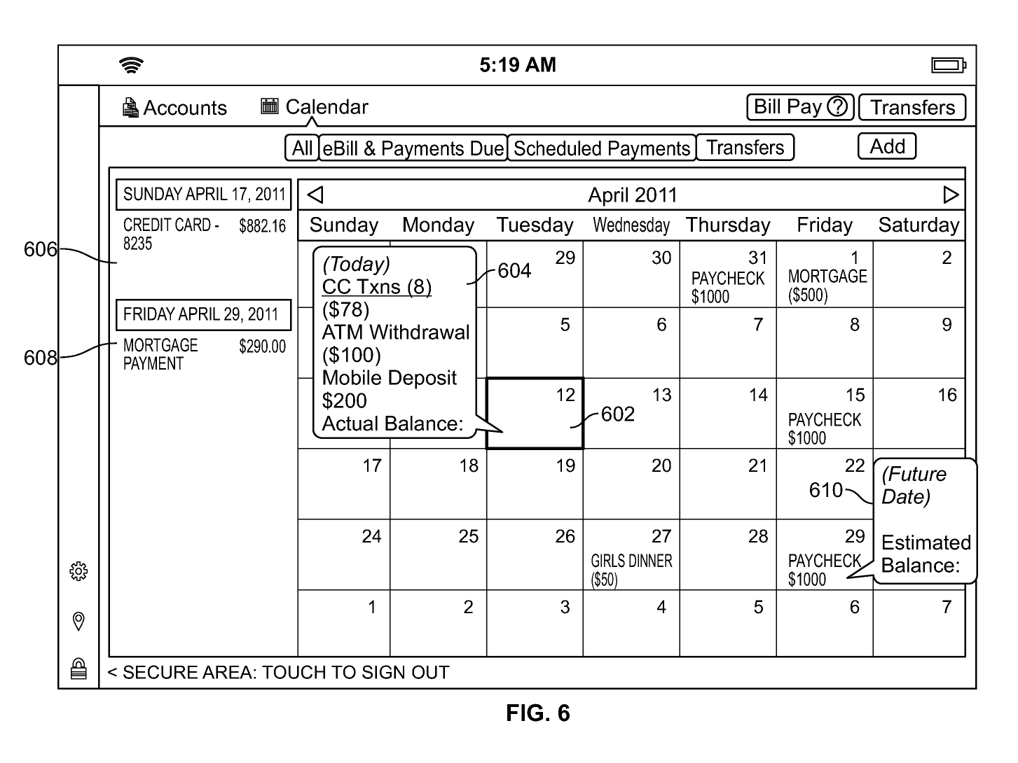

FIG. 6 shows an additional exemplary graphical display that may be generated and displayed by a calendar module in accordance with the systems and methods of the invention. In FIG. 6, the generated calendar display displays at least a portion of customer account activity on the calendar date on which it occurred.

In FIG. 6, the calendar is being generated for a customer on calendar date 602. Calendar date 602 represents Apr. 12, 2011. Balloon 604 displays account activity that occurred on calendar date 602. The account activity that occurred on calendar date 602 includes a CC Txnas (8), an ATM withdrawal and a mobile deposit. In some embodiments, the balloon may also display an account balance for one or more customer accounts that is associated with calendar date 602. The graphical display additionally includes balloon 610. Balloon 610 may include an estimated account balance for the calendar date Apr. 29, 2011.

The graphical display shown in FIG. 6 includes projected future payment 606 and projected future payment 608. Projected future payment 606 relates to a credit card payment of $882.16 on Apr. 17, 2011. Projected future payment 608 relates to a mortgage payment of $290.00 on Apr. 29, 2011.

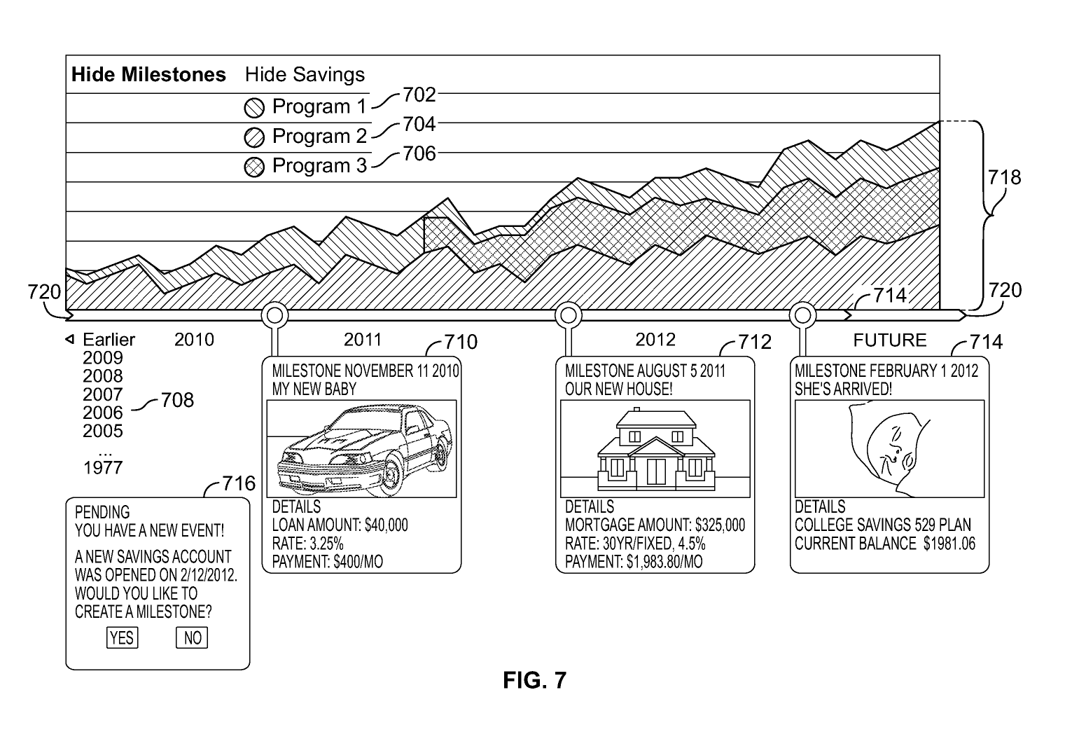

FIG. 7 shows an exemplary graphical display that may be generated and displayed by a timeline module in accordance with the systems and methods of the invention. In FIG. 7, a timeline module has calculated benefits 718 that a customer has and may potentially receive by participating in programs 702, 704 and 706 that are offered by a business.

In FIG. 7, the benefits are calculated for the calendar years displayed on timeline 720. It should be noted that the graphical display additionally includes selectable calendar years 708. The selection of a calendar year included in selectable calendar year 708 may prompt the timeline module to display benefits accrued as a result in participation in programs 702, 704 and 706 during the selected calendar year.

The timeline generated in FIG. 7 may additionally include milestones 710, 712 and 714. It should be noted that, in some embodiments, some or all of the information included in milestones 710, 712 and 714 may be information that a customer input into the consumer graphics engine. In some embodiments, some or all of the information included in one or more of milestones 710 and 712 may be customer information retrieved by the consumer graphics engine from one or more databases. In FIG. 7, milestone 710 may relate to the purchase of a car, milestone 712 may relate to the purchase of a house, and milestone 714 may relate to the birth of a new baby girl. In some embodiments, the milestones may include photographs and/or details relating to the financial implications of the milestone.

The display generated by the timeline module further includes balloon 716. Balloon 716 may present a customer with the option of adding a milestone to the timeline. The milestone offered to be added in balloon 716 may relate to a customer's opening of a new savings account.

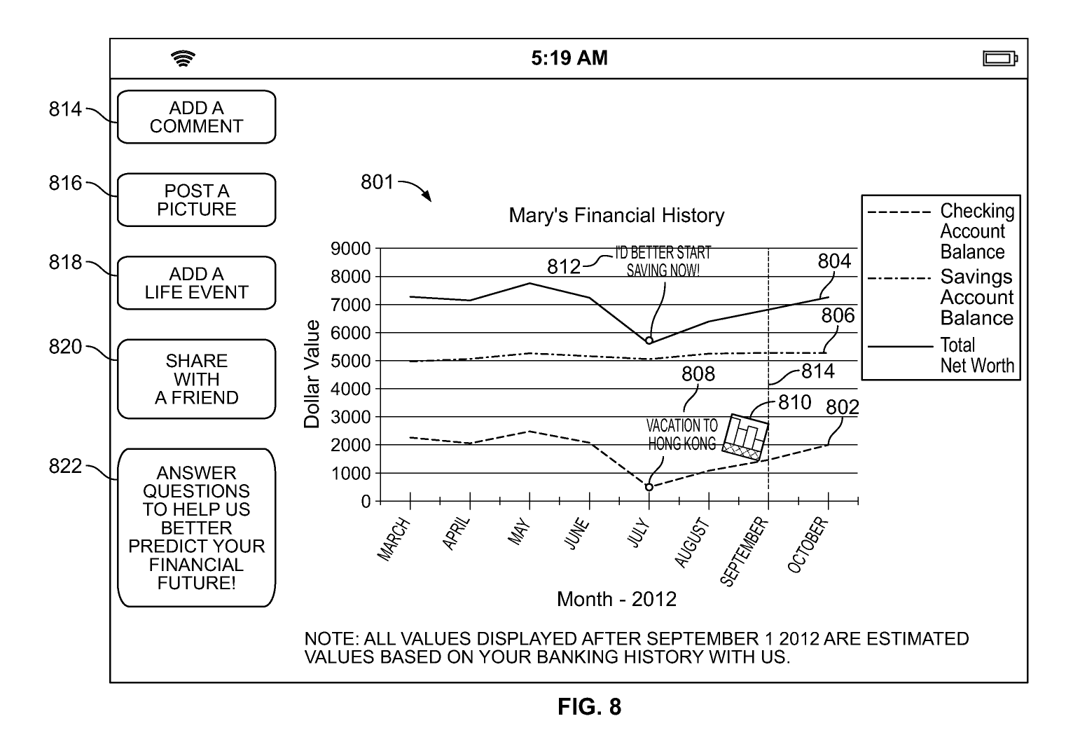

FIG. 8 shows an additional exemplary graphical display that may be generated and displayed by a timeline module in accordance with the systems and methods of the invention. FIG. 8 includes graph 801. Graph 801 may graph Mary's checking account balance 802, savings account balance 806, and total net worth 804 between the months of March, 2012 and October, 2012.

Graph 801 includes demarcation 814. Demarcation 814 may separate graphical values calculated using past customer data from graphical values calculated using projected data. Graph 801 additionally includes posted text 808 and posted text 812, in addition to posted photograph 810.

The timeline module may also display multiple selectable options proximal to graph 801. The multiple selectable options may include Add a Comment 814, Post a Picture 816, Add a Life Event 818, Share with a Friend 820, and Answer Questions to Help Us Better Predict Your Financial Future 822.

User selection of Add a Comment 814 may enable a user to add a comment to his graphed checking account balance 812, savings account balance 806, and/or total net worth 804. For example, in graph 801 Mary has added comment 812 ‘I'd better start saving now!’ when her total net worth took a dip in July of 2012. Additionally, in graph 801 Mary has added comment 808 ‘Vacation to Hong Kong’ to explain the dip in her checking account during July of 2012.

User selection of Post a Picture 816 may enable a user to upload and post a picture on a portion of graph 801. For example, in graph 801 Mary has uploaded a picture of her trip to Hong Kong. User selection of Add a Life Event 818 may enable a user to add text to graph 801 that identifies a life event that has happened or that he predicts to happen. Exemplary life events include the birth of a child, graduation, marriage, purchase of a house or car, and/or the opening of a savings or retirement account.

User selection of Share with a Friend 820 may enable a user to e-mail or otherwise electronically transmit at least a portion of graph 801 to a specified electronic destination. In some embodiments, the user may select which portions of graph 801 he desires to transmit and/or select which portions of graph 801 he desires to exclude from transmission.

User selection of Answer Questions to Help Us Better Predict Your Financial Future! may prompt the timeline module to display multiple questions with selectable answers and/or input fields. User selection of answers and/or input information in response to the displayed questions may prompt the timeline module to recalculate the predicted values for checking account balance 802, savings account balance 806 and total net worth 804. This functionality may enable a user to test the impact of various contemplated financial decisions on his financial life.

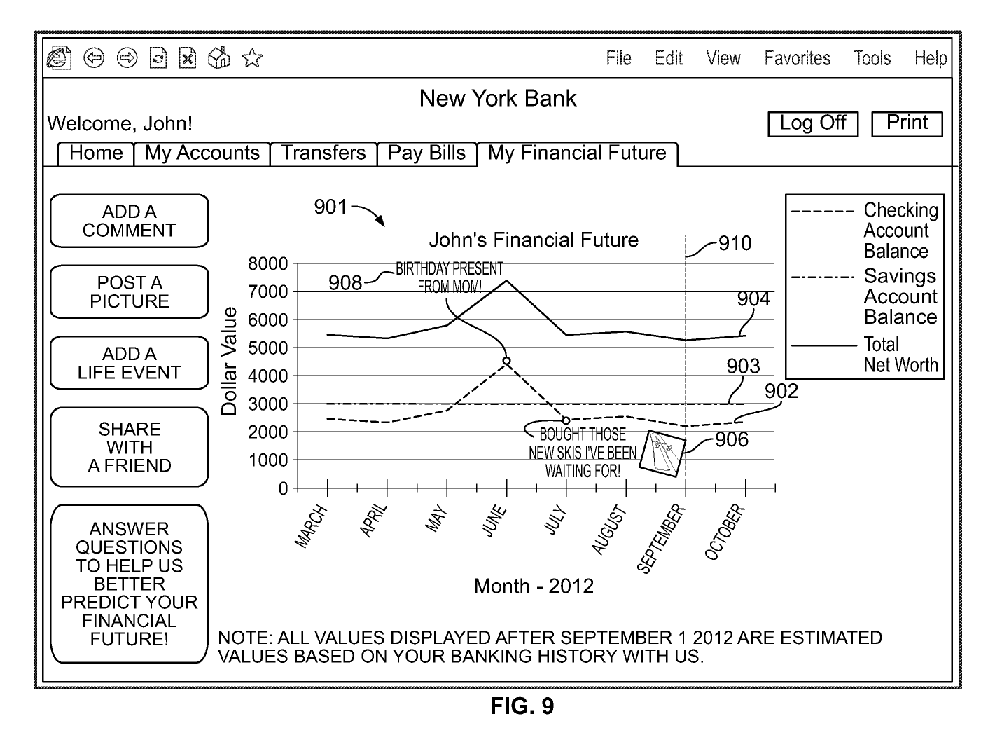

FIG. 9 shows an additional exemplary graphical display that may be generated and displayed by a timeline module in accordance with the systems and methods of the invention. FIG. 9 includes graph 901. Graph 901 may graph John's checking account balance 902, savings account balance 903, and total net worth 904 between the months of March, 2012 and October, 2012.

Graph 901 may additionally include posted comment 908 and posted comment and posted picture 906. Posted comment 908 may explain John's sudden increase in checking account balance 902 during June of 2012. Posted comment and posted picture 906 may explain John's sudden decrease in checking account balance 902 during July 2012.

Graph 901 may further include demarcation 910. Demarcation 910 may separate graphical values calculated using past customer data from graphical values calculated using projected data.

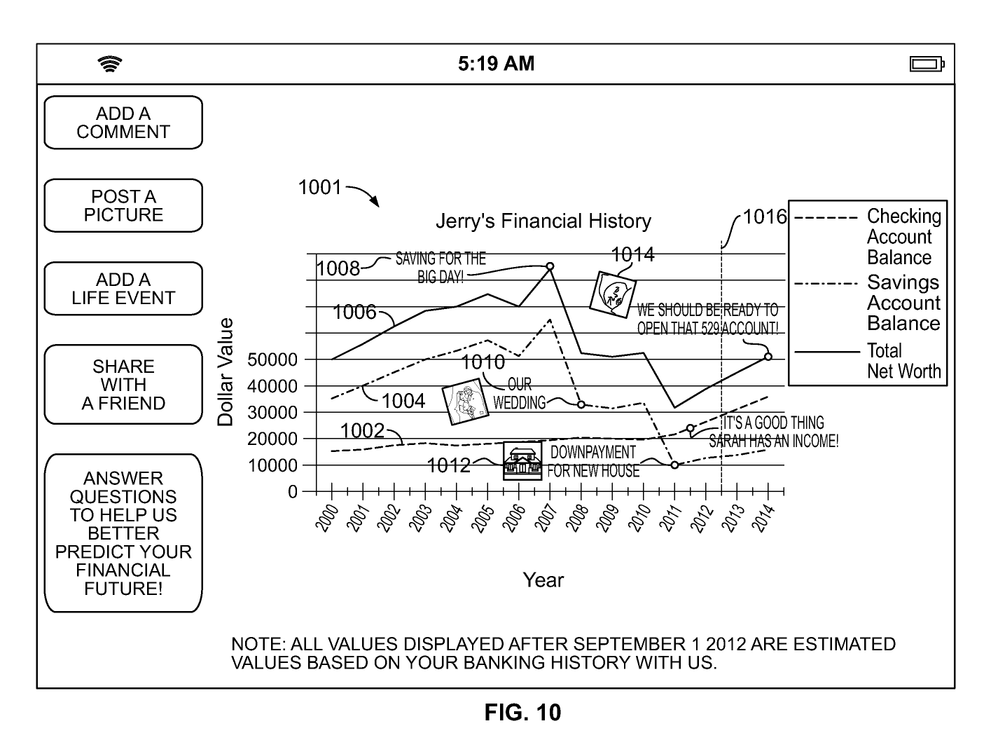

FIG. 10 shows an additional exemplary graphical display that may be generated and displayed by a timeline module in accordance with the systems and methods of the invention. FIG. 10 includes graph 1001. Graph 1001 may graph Jerry's checking account balance 1002, savings account balance 1004 and total net worth 1006 between the year 2000 and the year 2014. Graph 1001 may also include posted comment 1008 and posted comment and posted picture 1010, 1012 and 1014.

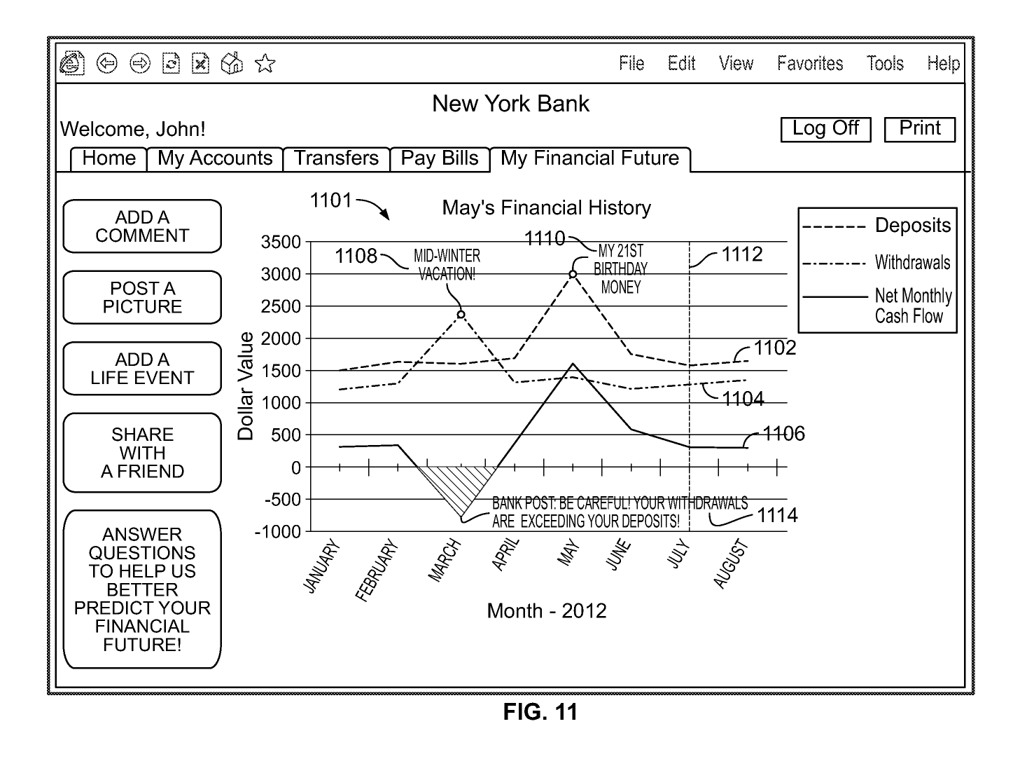

FIG. 11 shows an additional exemplary graphical display that may be generated and displayed by a timeline module in accordance with the systems and methods of the invention. FIG. 11 includes graph 1101. Graph 1101 may graph May's total monthly deposits 1101, total monthly withdrawals 1104 and net monthly cash flow 1106. FIG. 11 may additionally include May's posted comments 1108 and 1110. FIG. 11 may further include Bank's posted comments 1114. It should be noted that graphical display 1101 and a graphical display similar to graph 1101 may be used by banking personal when determining whether or not to lend May a sum of money.

Thus, methods and apparatus for creating consumer graphics in accordance with the systems and methods of the invention have been provided. Persons skilled in the art will appreciate that the present invention can be practiced in embodiments other than the described embodiments, which are presented for purposes of illustration rather than of limitation, and that the present invention is limited only by the claims that follow.

1. Apparatus for calculating and displaying a banking customer's banking history, the apparatus comprising:
a receiver configured to receive a first set of data relating to a plurality of deposits and a plurality of withdrawals, wherein each of the plurality of deposits and each of the plurality of withdrawals are associated with a numerical value and a calendar date;
a processor configured to display on a graphical user interface a timeline, the timeline being displayed in a first screen region and the timeline including a plurality of demarcations, each of the demarcations being associated with a calendar date, the timeline comprising a vertical or horizontal line;
the processor being further configured to display on the graphical user interface a plurality of balloons and an indicator that associates each of the plurality of balloons with a demarcation, each of the plurality of balloons being displayed in a second screen region, wherein:
each of the plurality of balloons includes information relating to one or more deposits included in the plurality of deposits or information relating to one or more withdrawals included in the plurality of withdrawals, the one or more deposits or the one or more withdrawals being associated with the same calendar date; and
a two-dimensional area occupied by each of the plurality of balloons is determined at least in part based on a sum of the values associated with the one or more deposits or the one or more withdrawals;
a receiver being configured to receive a repositioning command in response to the receipt of a second set of data relating to one or more deposits and one or more withdrawals; and
in response to the repositioning command, the graphical user interface being further configured to reposition the location of at least one of the plurality of balloons.

2. (canceled)

3. The apparatus of claim 2 wherein the one or more deposits or the one or more withdrawals are associated with the same calendar date as the demarcation associated with the balloon.

4. The apparatus of claim 1 wherein the data relating to the plurality of withdrawals includes data relating to the payment of a credit card bill.

5. The apparatus of claim 1 wherein the data relating to the plurality of withdrawals includes data relating to usage of a debit card to withdraw funds from a bank account.

6. The apparatus of claim 1 wherein the data relating to the plurality of deposits includes data relating to a deposit of a check at an automated teller machine.

7. The apparatus of claim 1 wherein the data relating to the plurality of deposits includes data relating to the deposit of a check using an automatic transmission of funds from an employer to the banking customer.

8. One or more non-transitory computer-readable media storing computer-executable instructions which, when executed by a processor on a computer system, perform a method for calculating and displaying a banking customer's banking history, the method comprising:
using a receiver configured to receive a first set of data relating to a plurality of deposits and a plurality of withdrawals, wherein each of the plurality of deposits are associated with a positive numerical value and a calendar date and each of the plurality of withdrawals are associated with a negative numerical value and a calendar date;
using a processor to display on a graphical user interface a timeline included in a first screen region, the timeline including a plurality of demarcations, each of the demarcations being associated with a calendar date;
using the processor to further display on the graphical user interface a plurality of balloons included in a second screen region, wherein:
each of the plurality of balloons includes information relating to one or more deposits included in the plurality of deposits and information relating to one or more withdrawals included in the plurality of withdrawals, the one or more deposits and the one or more withdrawals being associated with the same calendar date; and
a size of a two-dimensional area occupied by each of the plurality of balloons is determined at least in part based on a sum of the absolute values of each of the values associated with the one or more deposits and the one or more withdrawals associated with the same calendar date;
using a receiver to receive a repositioning command in response to the receipt of a second set of data relating to one or more deposits and one or more withdrawals; and
in response to the repositioning command, using the processor to reposition the location of at least one of the plurality of balloons.

9. The computer readable media of claim 8 wherein, in the method, the processor is further configured to display on the graphical user interface an indicator that associates each balloon with a demarcation.

10. The computer readable media of claim 9 wherein, in the method, the one or more deposits and the one or more withdrawals are associated with the same calendar date as the demarcation associated with the balloon.

11. The computer readable media of claim 8 wherein, in the method, the data relating to the plurality of withdrawals includes data relating to the payment of a credit card bill.

12. The computer readable media of claim 8 wherein, in the method, the data relating to the plurality of withdrawals includes data relating to usage of a debit card to withdraw funds from a bank account.

13. The method of claim 8 wherein the data relating to the plurality of deposits includes data relating to a deposit of a check at an automated teller machine.

14. The computer readable media of claim 8 wherein, in the method, the data relating to the plurality of deposits includes data relating to the deposit of a check using an automatic transmission of funds from an employer to the banking customer.

15. The computer readable media of claim 8 wherein, in the method, in the event that a sum of the values associated with the one or more deposits and the one or more withdrawals is negative, the two-dimensional area occupied by the balloon is displayed in the color red.

16. The computer readable media of claim 8 wherein, in the method, in the event that a sum of the values associated with the one or more deposits and the one or more withdrawals is positive, the two-dimensional area occupied by the balloon is displayed in the color green.
